(19) United States
(12) Patent Application Publication
(10) Pub. No.: US 2005/0278333 A1
(43) Pub. Date: Dec. 15, 2005

(54) METHOD AND SYSTEM FOR MANAGING PRIVACY PREFERENCES

(75) Inventors: Fonda J. Daniels, Cary, NC (US); Timothy E. Figgins, Raleigh, NC (US); Ajamu A. Wesley, Concord, MA (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/709,751

(22) Filed: May 26, 2004

(51) Int. Cl. G06F 7/00

(52) U.S. Cl. 707/9

(57) ABSTRACT

A method for managing privacy preferences or access to restricted information may include tagging restricted or personal information. The method may also include defining a content object with a link to the restricted or personal information. In another embodiment of the present invention, a method for privacy or access to restricted information may include collecting a content object in response to a request. The method may also include accessing privacy preferences of an author of the content object or other restriction preferences and comparing the privacy preferences or other restriction preferences to a content provider's policies.

### BACKGROUND OF INVENTION

The present invention relates to privacy of personal and other restricted information and more particularly to a method and system for managing privacy preferences attached to federated content or the like.

Today, web or Internet users are constantly faced with the decision of whether and under what circumstances to disclose personal information. Virtually any information including personal or private information is being stored electronically and may be accessed via electronic means. This makes managing access to personal or private information or other information to which one may desire to limit or restrict access a challenge. Authors who create papers or other works may have particular preferences in whether their personal information or to what extent such information is available when such papers or works are available via a network, such as the Internet. Such works or papers may be stored or reside as content objects in federated content repositories. Federated content may be maintained and owned by the contributing organization that initially authored or made available the content. As content is exchanged among business entities, privacy policies or preferences of federated content owners or authors needs to be honored and access controlled or managed, preferably automatically.

### SUMMARY OF INVENTION

In accordance with an embodiment of the present invention, a method for managing privacy preferences or access to restricted information may include tagging restricted or personal information. The method may also include defining a content object with a link to the restricted or personal information.

In accordance with another embodiment of the present invention, a method for managing privacy or access to restricted information may include collecting a content object responsive to a request. The method may also include accessing privacy preferences of an author or other restriction preferences and comparing the privacy preferences or other restriction preferences to a content provider's or web site's policies.

In accordance with another embodiment of the present invention, a system for managing privacy preferences or access to restricted information may include a server to collect a content object in response to a request. The system may also include a privacy function operable on the server to access privacy preferences of an author of the content object or other restriction preferences. Means may also be included for comparing the privacy preferences or other restriction preferences to policies of a content provider or web site.

In accordance with another embodiment of the present invention, a method for making a system for managing privacy preferences or access to restricted information may include providing a server to collect a content object in response to a request. A privacy function may be provided that is operable on the server to access privacy preferences of an author or provider of the content object or other restriction preferences. The method may also include providing means for comparing the privacy preferences or other restriction preferences to a content provider's or web site's policies.

In accordance with another embodiment of the present invention, a computer-readable medium having computer-executable instruction for performing a method including collecting a content object responsive to a request. The method may also include accessing privacy preferences of an author of the content object or other restriction preferences. The method may further include comparing the privacy preferences or other restriction preferences to policies of a content provider or web page.

### BRIEF DESCRIPTION OF DRAWINGS

FIG. 1 is a flow chart of a method for automatically managing privacy preferences or access to restricted information in accordance with an embodiment of the present invention.

FIG. 2 is an example of a content object illustrating how personal identification information may be identified or tagged in accordance with an embodiment of the present invention.

FIGS. 3A and 3B (collectively FIG. 3) are a flow chart of a method for automatically managing privacy preferences or access to restricted information in accordance with another embodiment of the present invention.

FIGS. 4A and 4B illustrate an example of a system and a sequence of operations that may be carried out by the system for automatically managing privacy preferences or access to restricted information in accordance with an embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

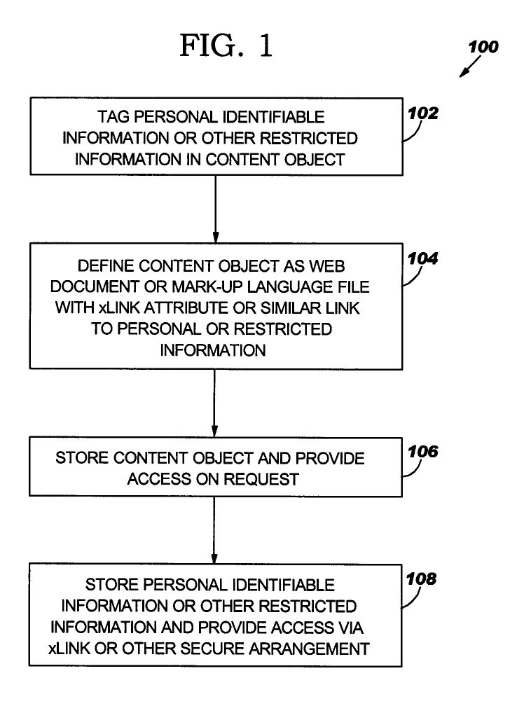

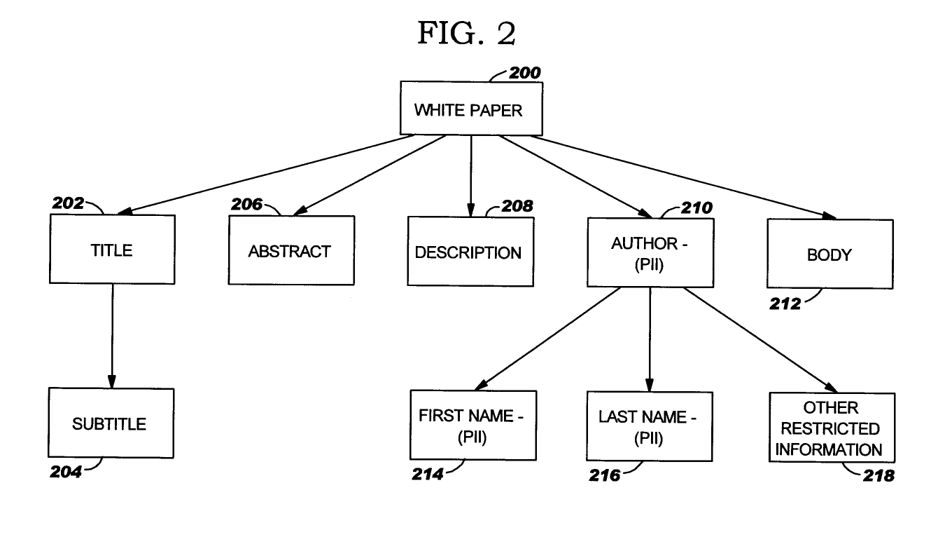

FIG. 1 is a flow chart of a method 100 for automatically managing privacy preferences or access to restricted information in accordance with an embodiment of the present invention. In block 102, personal identifiable information (PII), privacy information or other information to which access is intended to be restricted or limited may be tagged or otherwise identified in a content object. The content object may be a white paper, case study, press release, news article or any sort of document, viewable article or other work. FIG. 2 is an example of a content object 200 illustrating how personal identification information (PII) may be identified or may be tagged in accordance with an embodiment of the present invention. The example of the content object 200 illustrated in FIG. 2 is a white paper but may be any sort of document or viewable article as previously listed. The taxonomy of the white paper 200 may include different component parts, such as a title 202, subtitle 204, abstract 206, description 208, author PII 210 and body 212. The author PII 210 may include different components, such as first name 214, last name 216 and other restricted information 218, such as contact information, address, curriculum vitae or the like. As an example, the content object may be represented via a mark-up language, such as Extensible Markup Language (XML) or other representation that may be effectively stored and presented electronically on the Internet or other network as shown below. The XML schema may include Platform for Privacy Preferences Project (P3P) syntax that indicate elements that are considered PII (author complex type).

p3pwhitepaper.xsd
<xsd:schema xm lns:xsd =“http://www.w3.org/20001/XMLSchema”

xm lns:p3p =“http://www.w3.org/2001/12/P 3Pv1”>

```
<xsd:annotation>
  <xsd:documentation xml:lang=“en”>
  Whitepaper schema content object
  </xsd:documentation>
</xsd:annotation>
<xsd:element name=“whitePaper” type=“WhitePaperType”/>
<xsd:complexType name=“WhitePaperType ”>
<xsd:sequence>
  <xsd:element name=“title” type=“xsd:string”/>
  <xsd:element name=“subtitle” type=“xsd.string”/>
  <xsd:element name=“abstract” type=“xsd:string”/>
  <xsd:element name=“description” type=“xsd:string”/>
  <xsd:element name=“author” type=“Author”/>
  <xsd:element name=“body” type=“xsd:string”/>
</xsd:sequence>
<xsd:attribute name=“whitePaperDate” type=“xsd:date”/>
</xsd:complexType>
<xsd:complexType name=“Author”>
<xsd:sequence>
  <xsd:element name=“fname” type=“p3p:user.name.personname.given”/>
  <xsd:element name=“lname” type=“p3p:user.name.personname.family”/>
  <xsd:element name=“jobtitle” type=“p3p:user.jobtitle”/>
  <xsd:element name=“officeName” type=“p3p: business.name”/>
  <xsd:element name=“officeEmail” type=“p3p: business.contact-info.online.email”/>
  <xsd:element name=“officephone” type=“p3p:business.contact-
info.telecom.telephone.intcode”/>
  <xsd:element name=“officestreet” type=“p3p: business.contact-info.postal.street”/>
  <xsd:element name=“officecity” type=“p3p: business.contact-info.postal.city”/>
  <xsd:element name=“officestate” type=“p3p: business.contact-info.postal.stateprov”/>
  <xsd:element name=“officezip” type=“p3p: business.contact-info.postal.postalcode”/>
</xsd:sequence>
</xsd:complexType>
```

</xsd:schema>

In this example of a content object, the Personal Identifiable Information (PII) may be tagged or identified by a “type=p3p” type tag. While PII may be tagged or identified in this manner, any sort of information desired to be restricted or kept confidential may be identified or tagged with a p3p syntax or the like.

In block 104 of FIG. 1, the content object may be defined as an XML document or document accessible or presentable via the Internet, web or the like, with an xLink attribute or similar link to personal or restricted information. An example of the content object defined in an XML file with an xLink attribute to the author complex type elements is illustrated below. The xLink couples the author's P3P privacy preferences to the actual PII content.

p3pwhitepaper.xml
<?xml version =“1.0”?>
<whitePaper xmlns:p3p =“http://www.w3.org/2001/12/P3Pv1”

xmlns:xlink =“http://www.w3.org/1999/xlink”>

```
  <title “Title of the whitepaper”/>
  <subtitle “Subtitle of the whitepaper”/>
  <abstract “Abstract of the whitepaper”/>
  <description “Description of the whitepaper”/>
  <author xlink:type = “simple”
```

xlink: href = “www.ibm.com/content_preferences/contnet_privacy_prefs.xml”>

<p3p:fname “Fonda”/>
<p3p:lname “Daniels”/>
<p3p:jobtitle “Competitive Intelligence”/>
<p3p:officeName “IBM”/>
<p3p:officeEmail “fondad@us.ibm.com”/>
<p3p:officephone “919-224-1117”/>
<p3p:officestreet “3901 South Miami”/>
<p3p:officecity “Durham”/>
<p3p:officestate “NC”/>
<p3p:officezip “27709”/>

</author>
</whitepaper>

In block 106, the content object may be stored and access may be provided on request. In block 108, the personal identifiable information or other restricted information may also be stored in a different storage location or device. Access to the personal identifiable information or restricted information may be provided via an xLink, as illustrated above, or via some other secure arrangement or means.

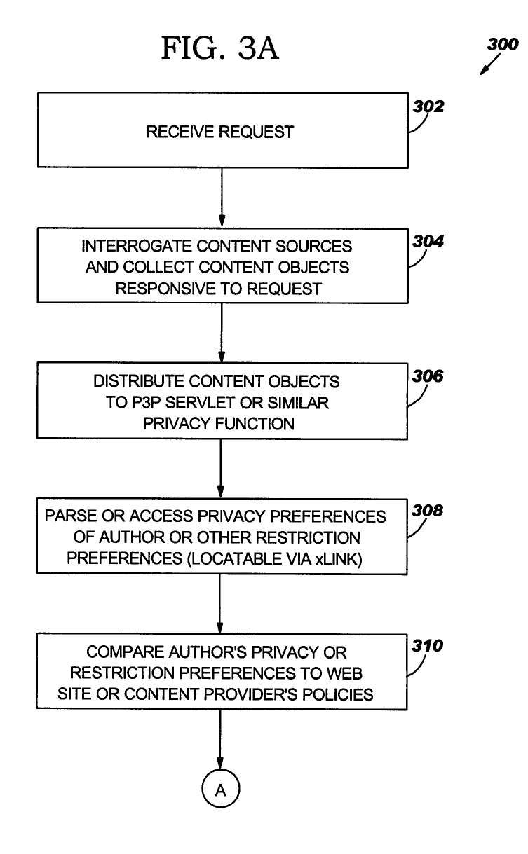

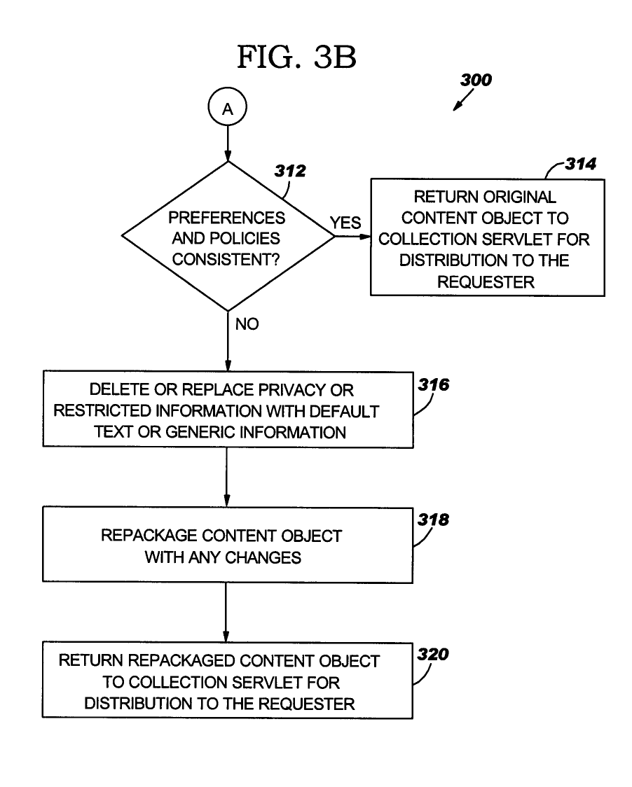

FIGS. 3A and 3B (collectively FIG. 3) are a flow chart of a method 300 for automatically managing privacy preferences or access to restricted information in accordance with another embodiment of the present invention. In block 302, a request may be received. The request may be received by a web server or like as will be discussed in more detail herein. The request may be for information, such as a white paper or other content object similar to the examples previously described. In block 304, sources that may contain the requested content object may be interrogated in response to the request. Content objects responsive to the request may be collected. As described in more detail herein, a collection function, such as a collection servlet operable on a web server, may interrogate the content sources and collect content objects responsive to the request.

In block 306, any content objects collected in block 304 may be distributed or transmitted by the collection function to a privacy function or P3P servlet. In block 308, the content object may be parsed to provide access to privacy preferences of the author of the content object or other restriction preferences. The privacy function or P3P servlet may parse the privacy preferences or other restriction preferences. The privacy preferences or restriction preferences may be accessed or located via an xLink associated with each of the components of the personal identifiable information or a similar link or access mechanism.

In block 310, the author's privacy preferences or other restriction preferences may be compared to the web site's or content provider's policies. The privacy function or P3P servlet may compare the privacy preferences or other restriction preferences to the web site's or service provider's policies. In block 312 (FIG. 3B), a determination may be made if the privacy or restriction preferences are consistent when compared to the policies of the web site or service provider. If the preferences and policies are consistent in block 312, the method 300 may advance to block 314 where the original content object may be returned to the collection function or servlet for distribution to the requester. If the preferences and policies are inconsistent in block 312 when compared in block 310, the method 300 may advance to block 316. In block 316, the privacy or restricted information may be deleted or replaced with default text or generic information. An example of default text may be “This information is unavailable” or a similar text or message. An example of generic information may be company information of the content provider or author. If the content object is modified in block 316, the content object may be repackaged by the privacy function or P3P servlet in block 318. In block 320, the repackaged content object may be returned to the collection function or collection servlet for distribution to the requester.

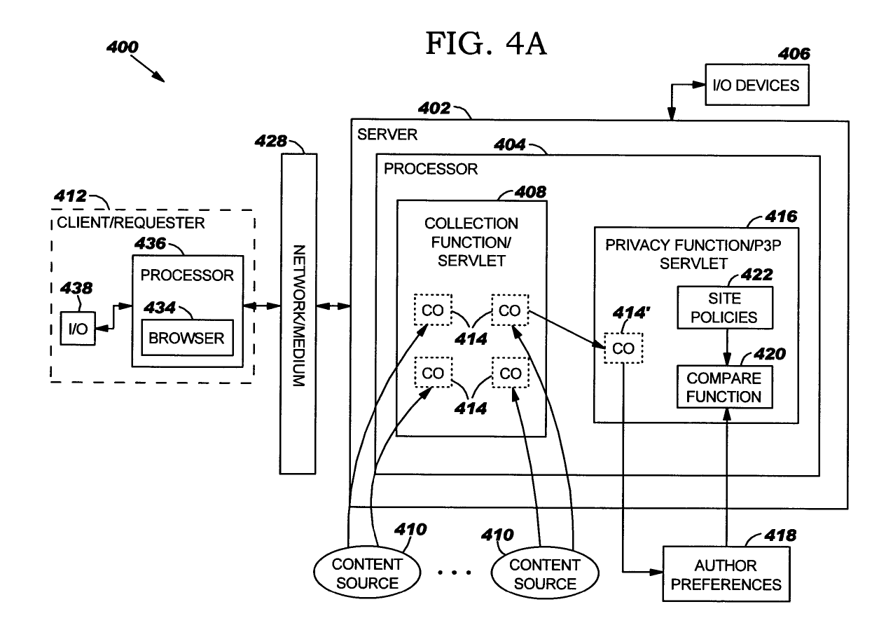

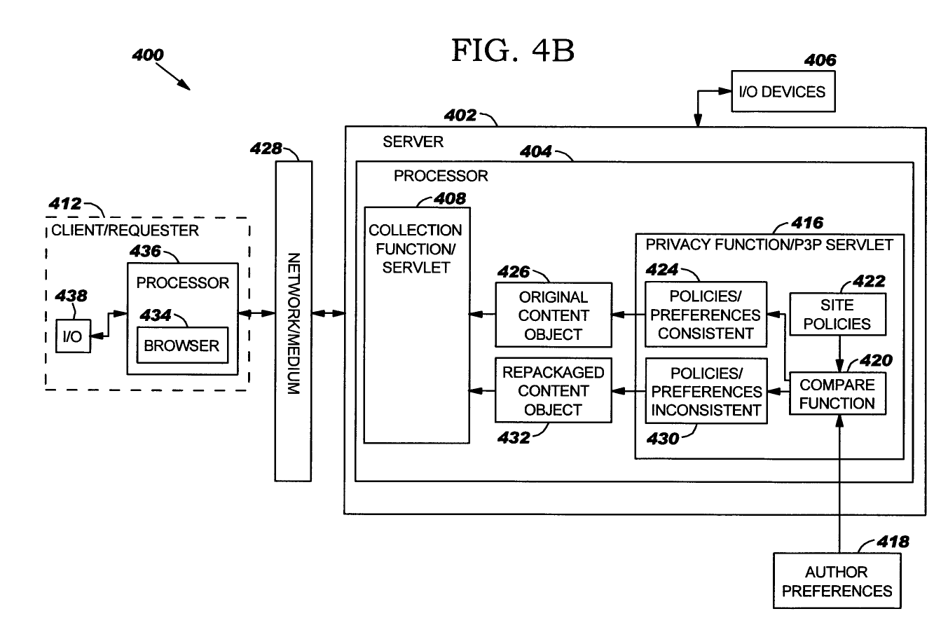

FIGS. 4A and 4B illustrate an example of a system 400 and a sequence of operations that may be carried out by the system 400 for automatically managing privacy preferences or access to restricted information in accordance with an embodiment of the present invention. The method 100 of FIG. 1 and method 300 of FIGS. 3A and 3B may be embodied in the system 400. The system 400 may include a server 402. The server 402 may be a web server or the like. Separate input and output (I/O) devices 406 or combination I/O devices may be coupled to the server 402 to provide an interface with the server 402 for programming purposes and to control operation of the server 402. The I/O devices 406 may include a keyboard, pointing devices, display or monitor, disk drives, optical, mechanical, or infrared I/O devices or the like.

The processor 404 may include a collection function or program 408 or the like. The collection function 408 may be a collection servlet analogous to aJava applet for operation in a web server environment. The collection function 408 may be adapted or programmed to interrogate a plurality of content sources 410 in response to a request from a client or requester 412 for selected information. The collection function 408 may also be adapted or programmed to collect content objects 414 from the sources 410 that may correspond to the request for information. The collection function or servlet 408 may transfer or distribute selected content objects 414′ to a privacy function or program 416 or the like. The collection function 408 may operate similar to that described with respect to blocks 302-306 in method 300 of FIG. 3.

The privacy function 416 or program may be a Platform for Privacy Preferences Project (P3P) based servlet or the like for operation in a web server environment. The privacy function 416 or P3P servlet may parse the content object 414′ to access the privacy preferences 418 of the author of the content object or to access other restriction preferences of the author or other entity providing the content object. The author's privacy preferences or other restriction preferences may be accessed or locatable via a link, secure connection or the like, such as an xLink, similar to that described with respect to block 308 of the method 300 in FIG. 3. The author's privacy preferences may be stored at a remote location from the server 402 or may be stored at another location within the server 402.

The privacy function 416 or servlet may include a compare function 420 to compare the author's privacy preferences 418 or other restriction preferences to the policies 422 of the web site or content provider. Referring also to FIG. 4B, if the author's privacy preferences or other restriction preferences are consistent (block 424) with the site policies 422 from the compare function 420, the content object 426 as originally constituted or formed may be returned to the collection function or servlet 408. The original content object 426 may then be distributed or sent to the requester 412 via a network or medium 428.

If the author's privacy preferences 418 or other restriction preferences are inconsistent (block 430) when compared to the site policies 422, the privacy or restricted information or data may be deleted or replaced with default text or generic information by the privacy function or servlet 416, similar to that described with respect to block 316 of FIG. 3B. The privacy function or servlet 416 may repackage the content object 414′ with the changes and the repackaged content object 432 may be returned to the collection function or servlet 408. The collection function or servlet 408 may then distribute the repackaged content object 432 to the requester 412 via the network or medium 428.

The network or medium 428 may be the Internet or a private network, such as an intranet or the like. The network or medium 428 may also be any communication network or system including by way of example, dedicated communication lines, telephone networks, and wireless data transmission systems, two-way cable systems, and customized computer networks, interactive kiosk networks or the like.

The requester 412 may access the network or medium 428 and the server 402 using a browser 434, such as a web browser or the like. The browser 434 may operate on a processor 436. Separate input and output devices 438 or combination I/O devices may be coupled to the processor 436 to permit a user or requester to operate and interface with the processor 436. The I/O devices 438 may be similar to the I/O devices 406 and may include a keyboard, pointing device, display or monitor, disk drives, optical, mechanical, magnetic, or infrared input/output devices or the like.

Elements of the present invention, such as method 100 of FIG. 1, method 300 of FIGS. 3A and 3B, and system 400 of FIGS. 4A and 4B, may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in a medium for use by or in connection with a system, such as system 400 of FIGS. 4A and 4B. Examples of such a medium may be illustrated in FIGS. 4A and 4B as medium 428 or I/O devices 406 and 438. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as the Internet or the like. The computer-usable or readable medium could also be paper or another suitable medium upon which the program may be printed.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for managing privacy preferences or access to restricted information, comprising:
tagging restricted or personal information; and
defining a content object with a link to the restricted or personal information.

2. The method of claim 1, wherein defining the content object comprises defining the content object as a web document or a mark-up language file.

3. The method of claim 1, further comprising associating an xLink attribute to the restricted or personal information.

4. The method of claim 1, further comprising:
storing the content object; and
providing access to the content object.

5. The method of claim 1, further comprising:
storing the restricted or personal information; and
providing access to the restricted or personal information via one of an xLink or a secure connection.

6. The method of claim 1, further comprising:
receiving a request for information;
interrogating content sources; and
collecting any content objects responsive to the request.

7. The method of claim 6, wherein collecting any content objects responsive to the request comprises using a collection servlet.

8. The method of claim 6, further comprising distributing any content object responsive to the request to a P3P servlet.

9. The method of claim 6, further comprising distributing any content object responsive to the request to a privacy function.

10. The method of claim 9, further comprising parsing privacy preferences of an author of the content object or other restriction preferences.

11. The method of claim 10, further comprising locating or accessing privacy preferences of an author of the content object or other restriction preferences using an xLink.

12. The method of claim of claim 9, further comprising comparing the privacy preferences of an author of the content object or other restriction preferences to a content provider's policies.

13. The method of claim 12, further comprising distributing original content object to a requester in response to the privacy preferences of the author of the content object or other restriction preferences being consistent with the content provider's policies.

14. The method of claim 12, further comprising:
deleting or replacing private or restricted information with default or generic information in response to the content privacy preferences of the author of the content object or other restriction preferences being inconsistent with the content provider's policies;
repackaging the content object in response to deleting or replacing the private or restricted information; and
distributing the repacked content object to a requester.

15. A method for managing privacy or access to restricted information, comprising:
collecting a content object responsive to a request;
accessing privacy preferences of an author of the content object or other restriction preferences; and
comparing the privacy preferences or other restriction preferences to a content provider's policies.

16. The method of claim 15, further comprising distributing the content object as originally constituted in response to the privacy preferences of the author of the content object or other restriction preferences being consistent with the content provider's policies.

17. The method of claim 15, further comprising:
deleting or replacing private or restricted information with default or generic information in response to the privacy preferences of the author of the content object or other restriction preferences being inconsistent with the content provider's policies;
repackaging the content object in response to deleting or replacing the private or restricted information; and
distributing the repacked content object to a requester.

18. The method of claim 15, further comprising using a collection servlet to collect the content object responsive to the request.

19. The method of claim 15 further comprising distributing any collected content object to a P3P servlet.

20. The method of claim 15, further comprising distributing any content object in response to the request to a privacy function.

21. The method of claim 20, further comprising parsing the privacy preferences of an author of the content object or other restriction preferences.

22. The method of claim 21, further comprising locating or accessing the privacy preferences or restriction preferences using an xLink.

23. A system for managing privacy preferences or access to restricted information, comprising:
a server to collect a content object in response to a request;
a privacy function operable on the server to access privacy preferences of an author of the content object or other restriction preferences; and
means for comparing the privacy preferences or other restriction preferences to a content provider's policies.

24. The system of claim 23, wherein the privacy function distributes the content object as originally constituted in response to the privacy preferences or other restriction preferences being consistent with the content provider's policies.

25. The system of claim 23, wherein the privacy function deletes or replaces private or restricted information with default or generic information in response to the privacy preferences or restriction preferences being inconsistent with the content provider's policies.

26. The system of claim 25, wherein the privacy function repackages the content object in response to deleting or replacing the private or restricted information.

27. The system of claim 23, further comprising a collection function operable on the server to interrogate content sources and collect content objects from the content sources in responsive to the request.

28. The system of claim 23, wherein the privacy function comprises a P3P servlet to access the privacy preferences or other restriction preferences via an xLink.

29. The system of claim 28, wherein the P3P servlet comprises means for comparing the privacy preferences or other restriction preferences to a web site or content provider's policies.

30. The system of claim 29, wherein the P3P servlet comprises means for transmitting the content object as originally constituted to a collection servlet in response to the privacy preferences or restriction preferences being consistent with the web site or content provider's policies.

31. The system of claim 30, wherein the P3P servlet comprises:
means for deleting or replacing private or restricted information with default or generic information in response to the privacy preferences or restriction preferences being inconsistent with the web site or content provider's policies;
means for repackaging the content object in response to deleting or replacing the private or restricted information; and
means for transmitting the repackaged content object to the collection servlet in response to deleting or replacing the private or restricted information.

32. A method of making a system for managing privacy preferences or access to restricted information, comprising:
providing a server to collect a content object in response to a request;
providing a privacy function operable on the server to access privacy preferences of an author of the content object or other restriction preferences; and
providing means for comparing the privacy preferences or other restriction preferences to a content provider's policies.

33. The method of claim 32, further comprising adapting the privacy function to distribute the content object as originally constituted in response to the privacy preferences or other restriction preferences being consistent with the content provider's policies.

34. The method of claim 32, further comprising adapting the privacy function to delete or replace private or restricted information with default or generic information in response to the privacy preferences or restriction preferences being inconsistent with the content provider's policies.

35. The method of claim 32, further comprising providing a collection function to interrogate content sources and to collect content objects responsive to the request.

36. The method of claim 32, further comprising providing a P3P servlet to access the privacy preferences or other restricted preferences via an xLink.

37. The method of claim 36, further comprising adapting the P3P servlet to compare the privacy preferences or other restriction preferences to a web site or content provider's policies.

38. The method of claim 37, further comprising adapting the P3P servlet to transmit the content object as originally constituted to a collection servlet in response to the privacy preferences or restriction preferences being consistent with the web site or content provider's policies.

39. The method of claim 38, further comprising adapting the P3P sevlet to:
delete or replace private or restricted information with default or generic information in response to the privacy preferences or restriction preferences being inconsistent with the web site or content provider's policies;
repackage the content object in response to deleting or replacing the private or restricted information; and
transmit the repackaged content object to the collection sevlet in response to deleting or replacing the private or restricted information.

40. A computer-readable medium having computer-executable instructions for performing a method, comprising:
collecting a content object responsive to a request;
accessing privacy preferences of an author of the content object or other restriction preferences; and
comparing the privacy preferences or other restriction preferences to a content provider's policies.

41. The computer-readable medium having computer executable instructions for performing the method of claim 40, further comprising distributing the content object as originally constituted in response to the privacy preferences of the author of the content object or other restriction preferences being consistent with the content provider's policies.

42. The computer-readable medium having computer executable instructions for performing the method of claim 40, deleting or replacing private or restricted information with default or generic information in response to the privacy preferences of the author of the content object or other restriction preferences being inconsistent with the content provider's policies;
repackaging the content object in response to deleting or replacing the private or restricted information; and
distributing the repacked content object to a requester.

43. The computer-readable medium having computer executable instructions for performing the method of claim 40, further comprising distributing any content object responsive to the request to a privacy function.

44. The computer-readable medium having computer executable instructions for performing the method of claim 43, further comprising parsing the privacy preferences of an author of the content object or other restriction preferences.

45. The computer-readable medium having computer executable instructions for performing the method of claim 44, further comprising locating or accessing the privacy preferences or restriction preferences using an xLink.
